(19) United States
(12) Patent Application Publication
(10) Pub. No.: US 2017/0066359 A1
(43) Pub. Date: Mar. 9, 2017

(54) PIVOT CONNECTION FOR TRUCK BODIES

(71) Applicant: ESCO Corporation, Portland, OR (US)

(72) Inventors: Ian Rissman, Hope Island (AU); Matthew J. Dunford, Brisbane (AU); Paul L. Heaphy, Stafford (AU); Gordon Simpson, Thornlands (AU); Po-Shen Paul Chou, Brisbane (AU); Carolyn Shapiro (Deceased), Portland, OR (US); Darrin Harding, Newberg, OR (US); Thomas J. McCall, Gresham, OR (US); Ryan J. Kreitzberg, Beaverton, OR (US)

(21) Appl. No.: 15/122,091

(22) PCT Filed: Feb. 27, 2015
(86) PCT No.: PCT/US2015/018176

§ 371 Date: Aug. 26, 2016

Related U.S. Application Data
(60) Provisional application No. 61/946,623, filed on Feb. 28, 2014.

(51) Int. Cl. B60P 1/28

(52) U.S. Cl. CPC B60P 1/283; B60P 1/286

(57) ABSTRACT

Dump truck bodies are mounted to truck frames by a hinge so the truck body can pivot about the hinge to eject a load from the truck body. Loads carried by these vehicles can be extreme and the cyclical stress can generate cracks in the hinges. An upper pivoting connection of a dump truck hinge has side members each with a mounting portion that join to the sides of rails of the body and a lower pivot portion. The upper hinge structure is pinned to a lower hinge portion on the truck chassis at the pivot portion. Bracing between the sides add strength to the pivoting connection.

### FIELD OF THE INVENTION

The present invention relates to truck bodies (also called “truck trays”), e.g., for hauling material in the mining industry. More specific aspects of this invention relate to truck bodies having improved pivot connections for securing the truck body to the truck chassis.

### BACKGROUND OF THE INVENTION

Large mining dump trucks are used around the world to haul material excavated by a mining machine such as a face shovel, cable shovel, hoe bucket and the like. In surface mining, for example, these mining dump trucks repeatedly travel a prescribed course that involves receiving a load of mined material from the excavating machine, traveling to a location to dump the received mined material, and returning to the excavating machine for another load of mined material. Many trucks, one after the other, are commonly used to haul the mined material away in a continuous manner.

These off-road mining vehicles are constructed to carry a prescribed load which includes the weight of the truck body plus the weight of the mined material in the truck body. As shown in FIG. 1, a dump truck 100 includes a truck body 200 (also called a truck tray) to hold the material during transit. The truck body 200 is mounted to the truck or tractor 102. While other designs are possible, truck bodies 200 of this type typically have an open top side 202 (providing access to the truck payload bed 204 from the top) and an open rear end 206. The front portion 208 of this example truck body 200 includes a forward extending canopy portion 210 that extends over and protects the roof of the truck cabin 104 and the truck 102, e.g., during loading of the truck body 200. Typically, the truck body 200 is fabricated of plate steel walls supported by a series of large structural beams or ribs 212 to carry the weight of the mined material and withstand the impacts associated with receiving the mined material from the excavating machine.

Standard truck bodies are typically designed with a hauling capacity in a variety of sizes including a range of 64 m³ to 412 m³, and generally weigh on the order of 14 to 70 metric tons.

When the load within the payload bed 204 is to be dumped out of the rear end 206 of the truck body 200, the front end 208 of the truck body 200 is moved upward so that the truck body pivots about an axis 401 of pivot pins 400. The truck body is pivoted about the pivot pins using, for example, hydraulics or other lifting or rotating mechanisms known and used in the industry (not shown).

The hinge structure is shown generally in FIG. 2. The hinge structure includes a two pivot connections 300 connected to the body, i.e., one along each rail to support the pivot pins for the truck body. Each pivot connection 300 is primarily formed of two parallel plate members 308, 310 joined to opposite sides of one of the chassis rails 214. Each plate member has a mounting end 302 that is typically welded to the chassis rails 214 of the truck body 200, a downwardly projecting cantilevered section 304, and a pivot end 306 to pivotally connect the truck body 200 to the chassis 106 of the tractor 102. The plate members 308, 310 of pivot connection 300 are made of plate steel.

When the pivot connection 300 is secured to the chassis rail 214, one plate member 308 is welded along the outside surface of the chassis rail to define an outside plate or left arm 308 of the pivot connection, and the other plate member 310 is welded along the opposite inside surface of the chassis rail to define an inside plate or right arm 310 of the pivot connection. Plate members 308, 310 are then separated from each other by the width of the chassis rail 214. Each plate member 308, 310 includes an aperture or through hole 312, which are aligned to receive a pivot pin 400 to couple the truck body 200 to the chassis 106 via pivot connection 300. A fabricated boss 314 may be welded in the through hole 312 or welded around the through hole on one of the sides of the arms of the pivot connection. The boss provides additional support to the through hole for resisting the high loads applied during use.

As the truck body is pivoted to dump the load, the weight of the truck body plus the weight of the mined material in the truck tends to make the arms of each pivot connection bend and deflect from side to side (i.e., in the direction of the pivot axis 401). The bending and deflecting creates high stresses in the pivot connection 300. These high stresses are experienced cyclically each time the truck body 200 is raised and lowered. The pivot connections 300 are known to experience particularly high stress at the mounting end 302 of pivot connection and at the aperture 312. The high stress may lead to premature failure of the pivot connection (e.g., the pivot connection may become separated from the truck body, the boss may be bent within the through hole, or the area around the aperture may crack). In an effort to minimize the bending and deflection experienced by the plate members 308, 310 of pivot connection 300, a transverse plate (not shown) has sometimes been welded centrally between the left and right arms of the pivot connection in a vertical orientation to define an additional support.

While this arrangement tends to strengthen the pivot connection, these arrangements can still suffer the same problems as pivot connections without the transverse support plate. Moreover, if the pivot connection has been heat treated for enhanced strength, the high heat associated with welding may weaken the plate members and diminish the benefits of the heat treatment of the pivot connection. In addition, the welding may create new zones of stress along the new welds. The transverse support plate also does nothing to reduce the stress of the weld around the aperture. The premature failure of the pivot connection will lead to more frequent repair and maintenance of the pivot connection, and can also lead to the truck body and/or the truck chassis needing costly maintenance to repair the damage done by the failed pivot connection. Increased maintenance leads to decreased productivity.

### SUMMARY OF THE INVENTION

The present invention relates to a pivot connection for securing a truck body to a truck chassis of a dump truck. The pivot connection is particularly well suited for large off-road mining dump trucks.

In one aspect of the invention, the pivot connection is made of one-piece side members manufactured by casting, forging or other processes available to create the desired one-piece construction. A one-piece side member can provide a number of benefits such as improved transitions between adjacent portions of the side member for reduced stress, various reinforcements for increased strength, fewer parts and welds for easier manufacture and enhanced strength, and strategic thinning or recess for reduced weight. In addition, the material properties of the cast components can be tailored and controlled to make a stronger pivot connection, and weaknesses caused by welding the components together can be avoided. In one preferred construction, the pivot connection is a one piece component with two opposing arms and a transverse support connecting the arms.

While a one-piece pivot connection or a pivot connection comprising a one-piece side member (e.g., a cast pivot connection or cast side members) can provide a number of benefits over standard fabricated pivot connections, certain benefits can also be achieved through the use of a one-piece component with two or more parts fabricated together by welding or other means. For example, further aspects of the invention include one-piece side members that include (1) a projecting pivot portion, a through hole for receipt of a pivot pin, and an enlarged boss free of sharp corners and/or welding for increased strength and durability, and reduced concentrations of stress, (2) thinning walls and/or recesses for increased weight savings, and/or (3) portions of transverse supports to define half components that can be welded together to form two-piece pivot connections. The one-piece side members can be joined together by one or more separate transverse supports welded or otherwise secured to the two one-piece side members.

In another aspect of the invention, a pivot connection is formed of spaced side members each having a mounting portion and a projecting pivot portion, where the side members are joined by a transverse gusset that has a longitudinal extension for increased strength and durability.

In another aspect of the invention, a pivot connection is formed of spaced side members each having a mounting portion and a projecting pivot portion, where the side members are joined by a transverse gusset that generally follows the periphery of the projecting pivot portion for increased strength and durability, and reduced stress concentrations.

In one example construction, the transverse gusset following the periphery of the projecting side members is recessed relative to the outer edges of the side members to ensure proper clearance to facilitate the necessary pivot action of the truck body without binding, or creating undue wear or particularly high stress concentrations.

In one example construction, a medial support generally aligned with the through holes in the pivot portions to interconnect the side members above the transverse gusset for increased support and strength.

In another aspect of the invention, a pivot connection is formed of a pair of spaced side members each having a mounting portion and projecting pivot portion, and a transverse gusset with a leading portion and a trailing portion that converge toward each other as they extend toward the through hole forming the pivot axis for the tuck body. The leading portion generally extends toward the front end of the truck body from the pivot axis, and the trailing portion generally extends toward the rear end of the truck body from the pivot axis. The use of a transverse gusset having this configuration provides increased strength and durability to the pivot connection.

In one example construction, the converging leading and trailing portions of the transverse gusset have differing slopes as they extend away from the through hole forming the pivot axis in the pivot connection to increase strength and lessen stress concentrations; i.e., in a preferred construction, the leading portion has a steeper slope than the trailing portion.

In another aspect of the invention, the pivot construction includes a pair of spaced side members including thinned wall portions and/or recesses to reduce weight without unduly reducing the strength and durability of the pivot connection.

In another aspect of the invention, a pivot connection is formed without rib recesses. The stronger formation of the pivot connection of the present invention enables the use of a shallower pivot connection that is capable of being welded only to that portion of the chassis rail that projects beneath the transverse ribs of the truck body. Forming the pivot connection without the rail recesses tends to lessen the severity of high stress points.

In another aspect of the invention, a pivot connection is defined as part of the chassis rail. The pivot connection may be manufactured with the pivot connections as an integral, part of the chassis rail, or the truck body may be retrofit such that the chassis rails are cut and the pivot connections are welded in place.

In another aspect of the invention, a hinge structure provides rotation of a truck body on a truck frame. The hinge structure comprises a mounting portion to attach to the truck body, pivot members projecting below the mounting portion at a mid-portion of the structure and a brace between the pivot members extending from a front portion to a back portion generally following the projecting pivot member.

In another aspect of the invention, a pivot connection to connect a truck body to an off-road truck frame comprises spaced side members, each having a mounting portion and a projecting pivot portion, where the side members are joined by a crosspiece that generally follows the periphery of the projecting pivot portion to limit relative motion of the side members.

In another aspect of the invention, a hinge portion for a truck body comprises side plates connected by an arcuate transverse support between them, each plate with aligned coupling portions that receive a pin to connect the pivot connection to a truck frame.

In another aspect of the invention, a pivot connection is formed of spaced side members each having a mounting portion and a projecting pivot portion. The side members each have a front edge and a rear edge that converge generally toward the through hole for receiving the pivot pin, and an arc-shaped outer edge along the mounting portion. The mounting portion is adapted to mount in an arced recess in the chassis rail. Mounting the pivot connection within the recess in the chassis rail allows for reduced stress between the pivot connection and the chassis rail.

### BRIEF DESCRIPTION OF THE DRAWINGS

The present invention is illustrated by way of example and is not limited by the accompanying figures, in which like reference numerals indicate the same or similar elements throughout. To simplify the drawings certain features of the truck and truck body have not been included. For example, the hydraulics and other lifting or rotating mechanisms for dumping the truck body are not shown.

FIG. 1 illustrates an example truck including a truck body.

FIG. 2 is a perspective view of prior art pivot connections secured to a truck body.

FIG. 3 is a perspective view of a truck body with one prior art pivot connection and one inventive pivot connection.

FIG. 4 is a partial cross-sectional view taken along the longitudinal axis of the inventive pivot connection.

FIG. 5 is a side perspective view of a pivot connection.

FIG. 6 is another side perspective view of a pivot connection.

FIG. 7 is another side perspective view of a pivot connection.

FIG. 8 is a perspective view of a pivot connection in accordance with the present invention installed over one chassis rail of a truck body, and one prior art pivot connection installed over the other chassis rail.

FIG. 9 is a side perspective view of one piece of an alternative two piece pivot connection.

FIG. 10 is a side perspective view of the second piece of the alternative two piece pivot connection, i.e., to fit together with the component shown in FIG. 9.

FIG. 11 is a side perspective view of an alternative pivot connection.

FIG. 12 is a bottom perspective view of alternative pivot connections secured to the rails of a truck body.

FIG. 13 is a partial, axial cross sectional view of one of the pivot connections shown in FIG. 12.

FIG. 14 is a side view of one side of a pivot connection of FIG. 12.

FIG. 15 is a rear view of one side of a pivot connection of FIG. 12.

FIG. 16 is a bottom view of one side of a pivot connection of FIG. 12.

FIG. 17 is a perspective view of one side of a pivot connection of FIG. 12.

### DETAILED DESCRIPTION OF THE PREFERRED EMBODIMENTS

The present invention relates to a dump truck for hauling material from one location to another. The dump truck has a truck body with an improved pivot connection for securing the truck body to the truck chassis. The pivot connection is particularly well suited for large off-road mining dump trucks.

Relative terms such as front, rear, top, bottom and the like are used for convenience of discussion, and are generally used to indicate the orientation of the pivot connection while the dump truck moves forward with the truck body in a lowered state such that the truck body rests on the truck chassis. Nevertheless, it is recognized that when dumping the load within the truck body the pivot connection may be oriented in various ways and move in all kinds of directions during use.

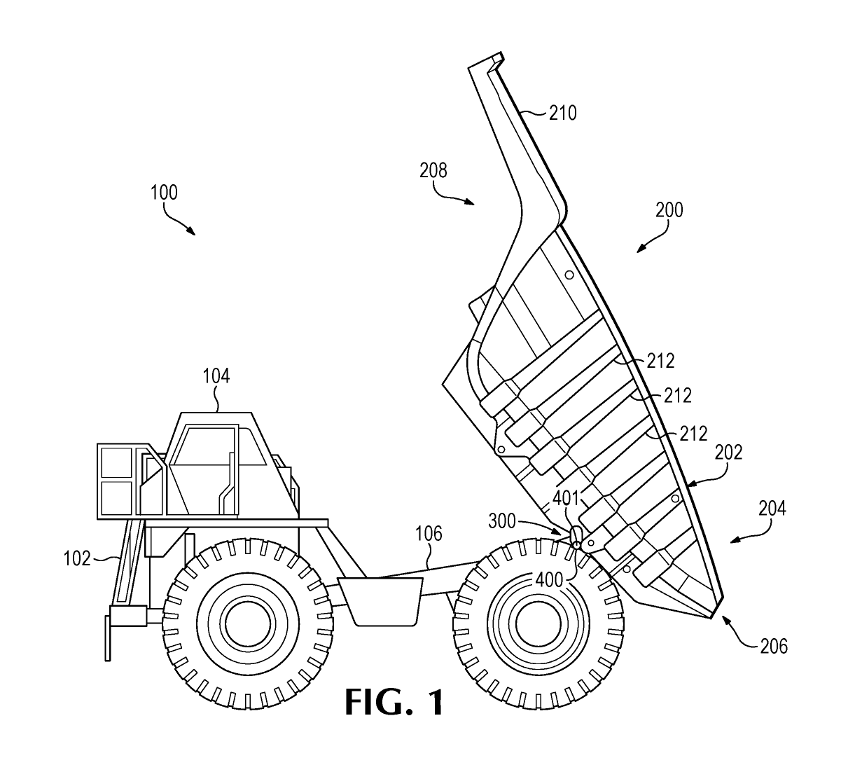

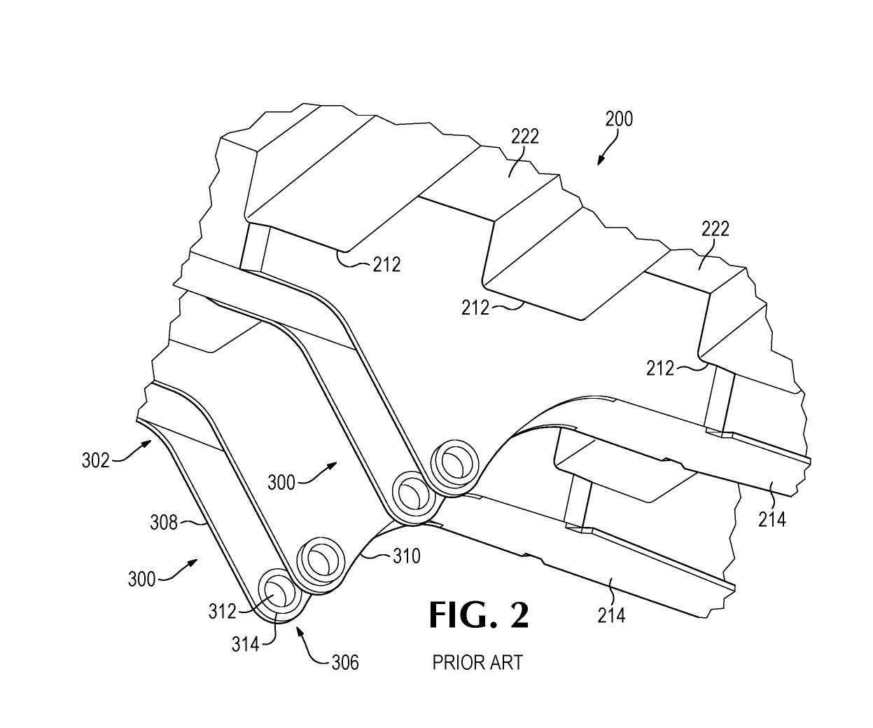

A truck body 200 shown generally in FIG. 1 is coupled to a truck chassis by a hinge for rotating the truck body to a dumping orientation. The truck body is fabricated of plate steel walls supported by a series of ribs 212. Chassis supports 214 extend along the longitudinal length of the truck body to support the truck body. Multiple configurations of truck bodies are known and variations in truck body geometry exist; for example, the truck body may have different shapes and sizes, may have different configurations of ribs or other supports, may have more, fewer or no ribs, may have an open top 202 and rear end 206, or may have covers (not shown) or a tailgate (not shown) could be provided to at least partially cover one or more of the top side 202 or rear end 206. The specific geometry of the truck body disclosed in this application is simply an example and is not intended to be limiting; pivot connections in accordance with the present invention can be used with various types of truck bodies.

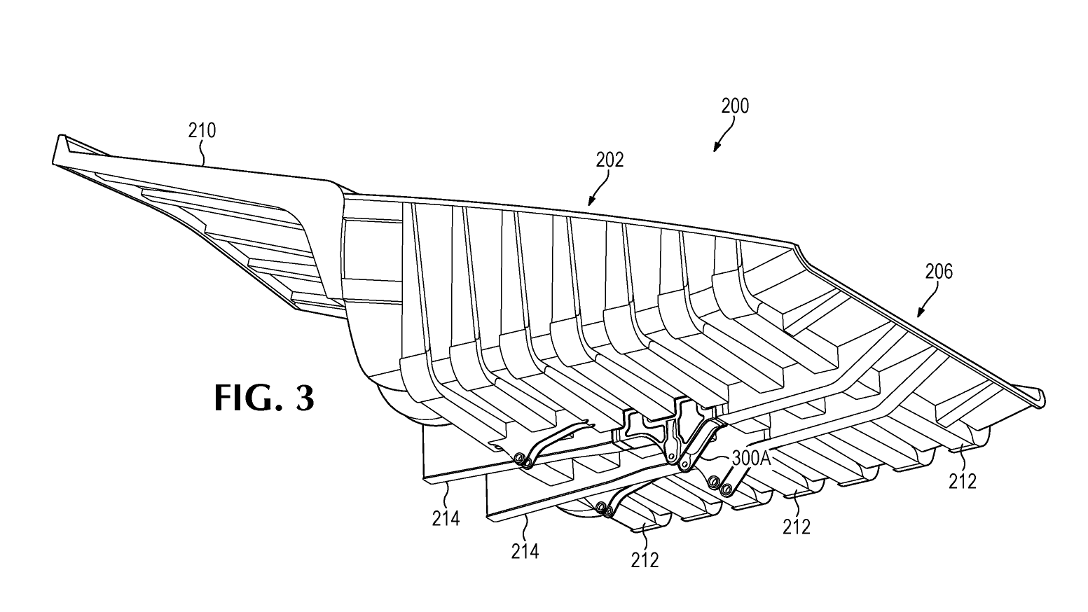

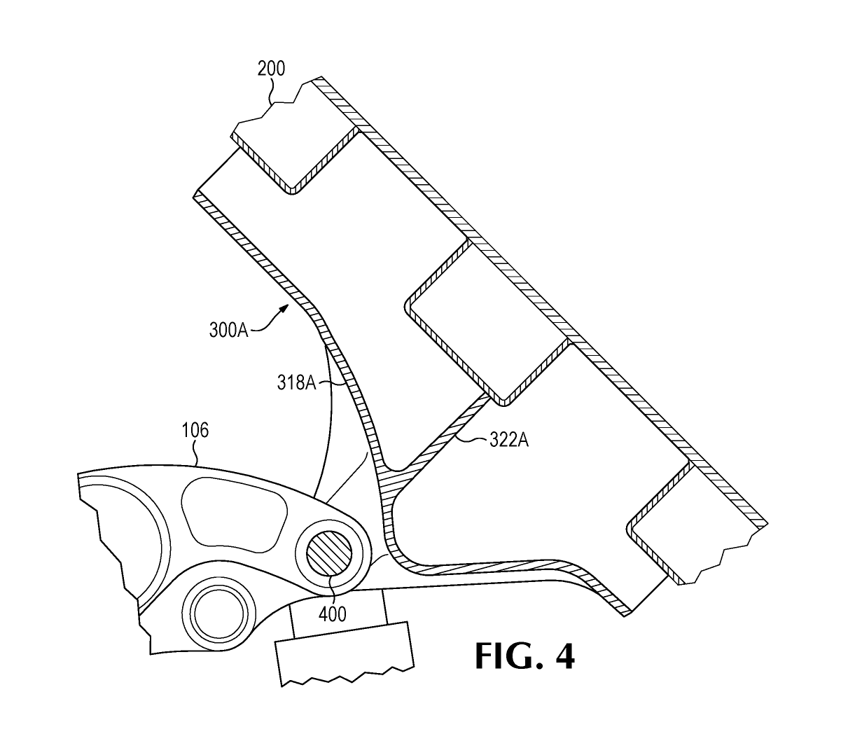

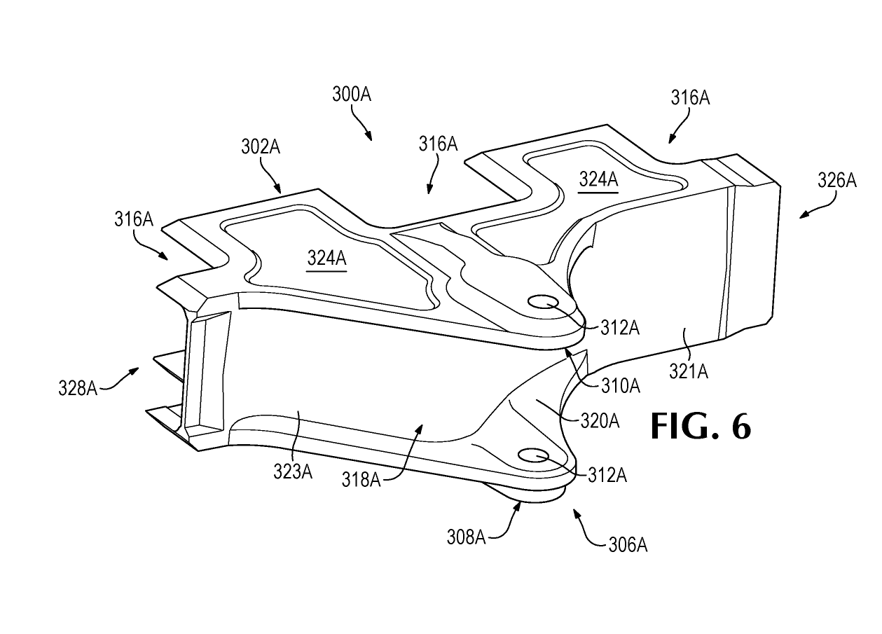

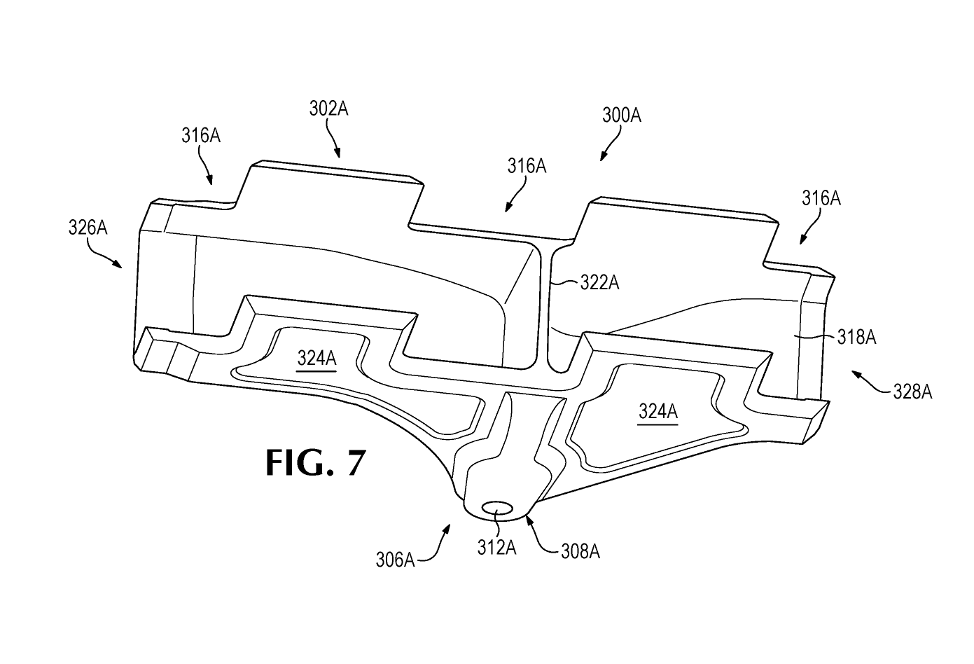

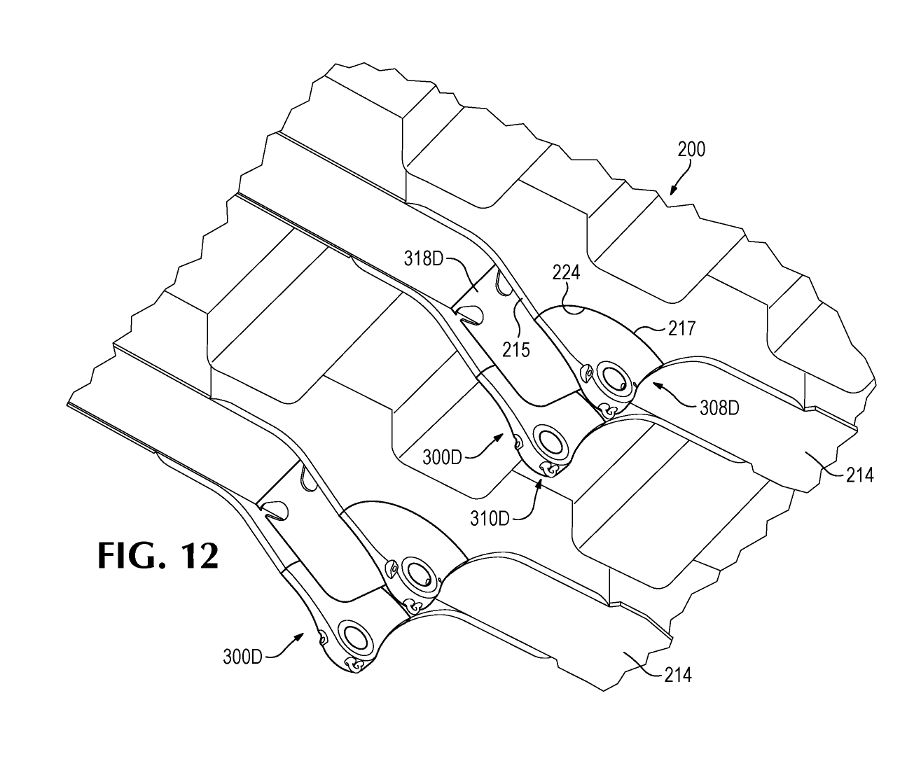

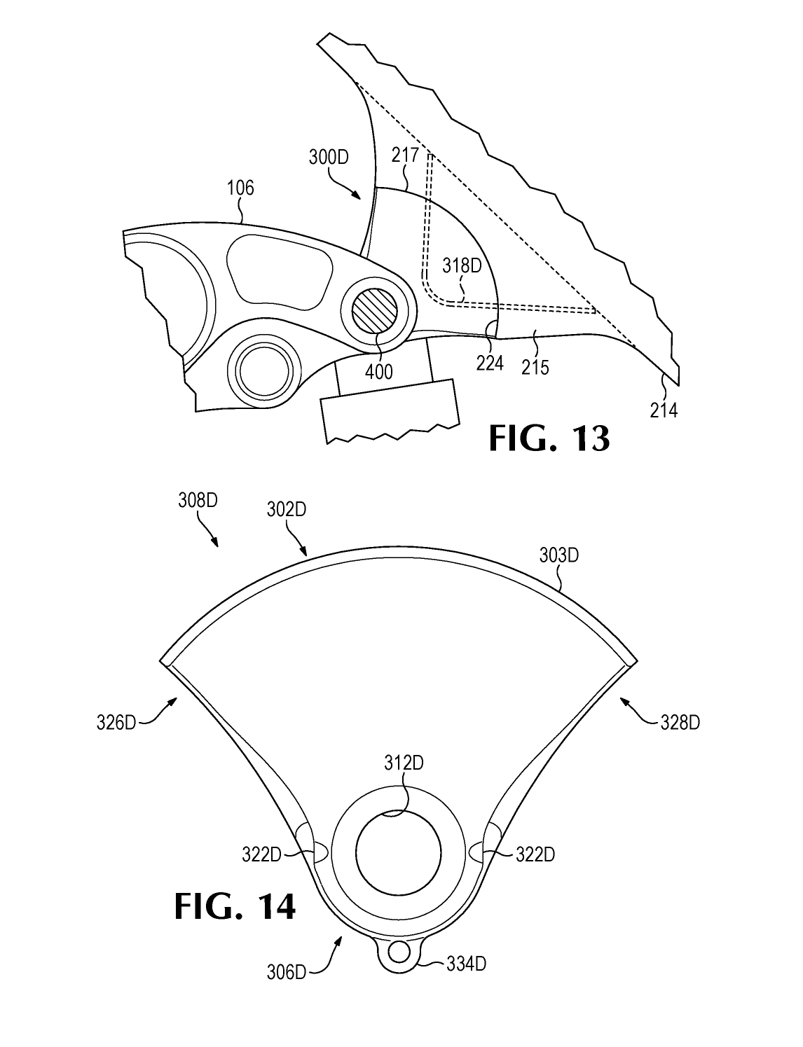

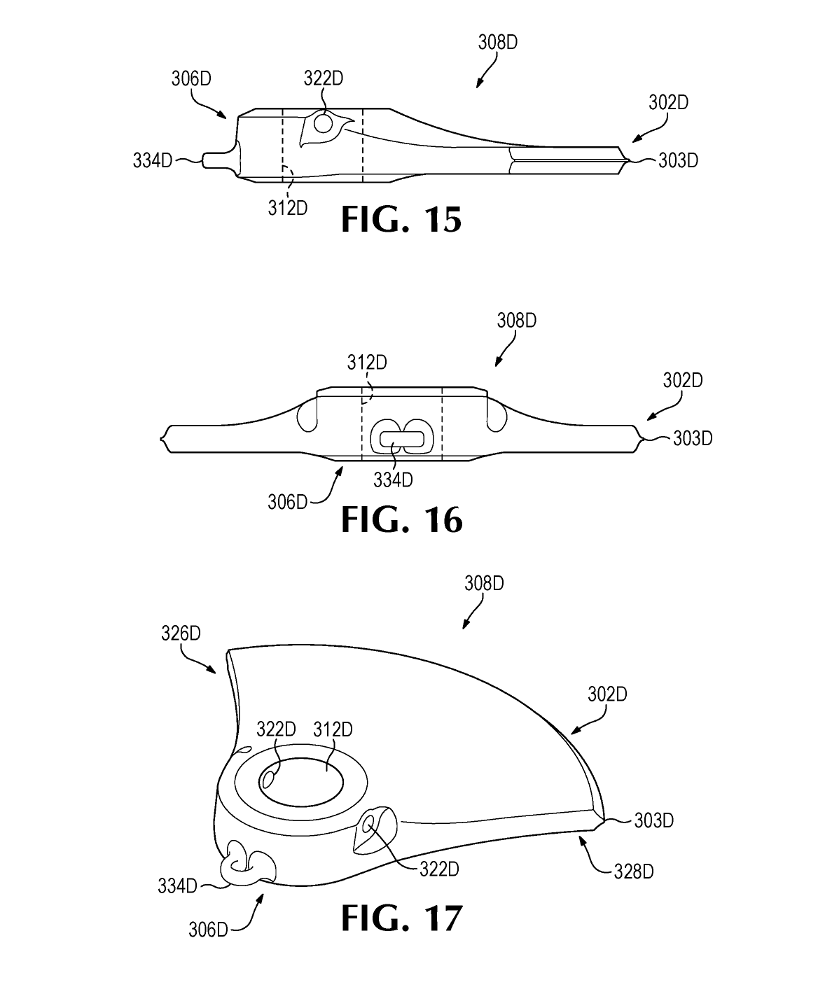

The truck body 200 is provided with an embodiment of a pivot connection or hinge structure 300A in accordance with the present invention. Pivot connections are shown generally in FIGS. 3-17. Pivot connection 300A includes spaced side or pivot members 308A, 310A interconnected by one or more transverse supports 318A, 322A. Each side member 308A, 310A includes a mounting end 302A that is secured by welding or other known securing arrangements to one of the chassis rails 214 of the truck body 200, and a coupling portion or pivot end 306A that projects from the truck body to connect the truck body to the truck chassis. The coupling or pivot portion includes a pivot hole or aperture 312A for receiving a pin 400. Alternatively, the pivot connection could include a single centrally (or otherwise) located aperture to receive pivot pin 400. The truck body 200 and the truck chassis are aligned such that the aperture 312A of the pivot connection 300A is aligned with an aperture on the truck chassis 106. Once the apertures are aligned, a pivot pin 400 is installed in the apertures. A securement mechanism (not shown) may be used to hold the pin in place. The securement mechanism may be, for example, a cotter pin, a bolt with or without a nut, a cover plate, or a retaining ring.

Pivot connection 300A is preferably a one piece casting, though the one-piece component could be forged or made by other processes to achieve the preferred one-piece construction. The mounting end 302A of the pivot connection is in this embodiment generally planar and generally rectangular. The mounting end 302A can include protrusions and recesses 316A formed to fit around the transverse ribs of the truck body.

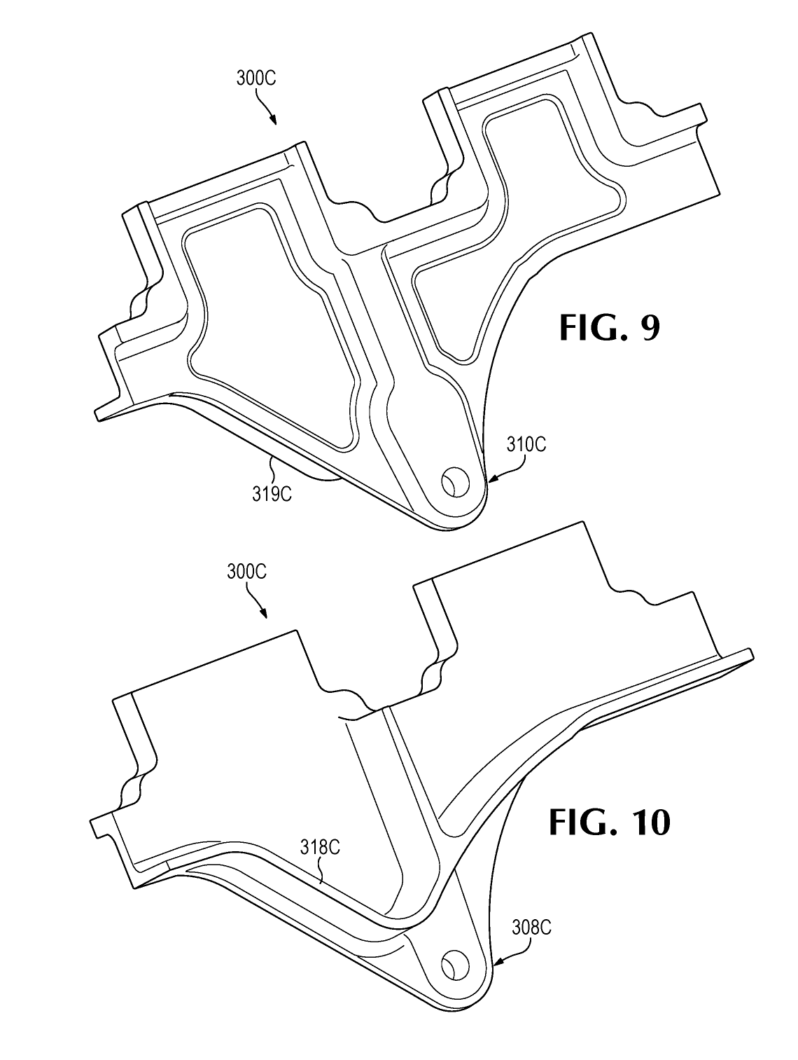

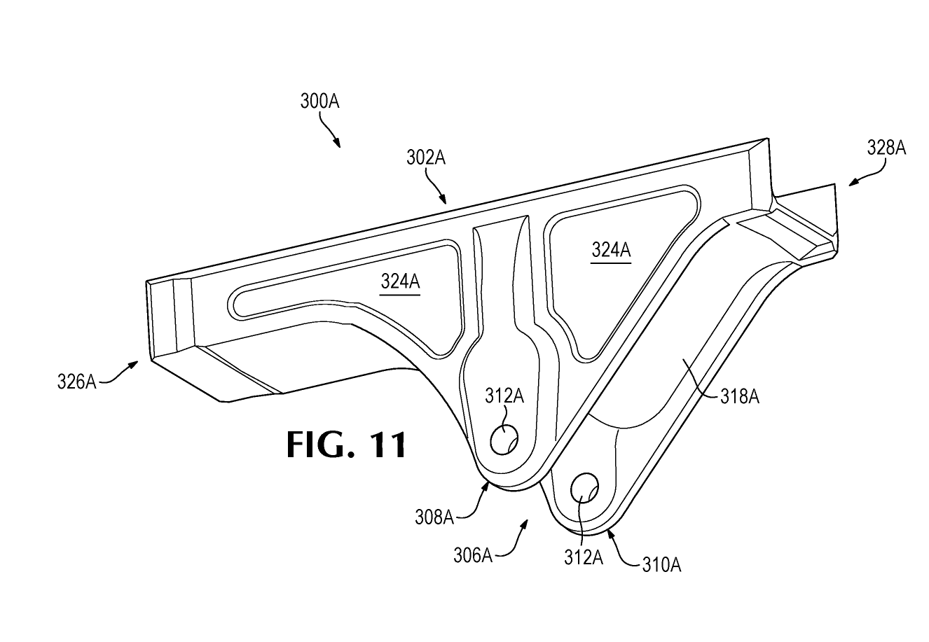

Nevertheless, the mounting portion 302A could have other shapes and constructions adapted to be secured to the chassis supports or other portions of the truck body. For example, mounting end 302A in one embodiment does not extend between ribs as shown in FIG. 11. Alternatively, the mounting end may have arced sections that fit in arced recesses in the chassis rail as discussed below.

The pivot end 306A of the pivot connection 300A consists of a pair of spaced apart side members or arms 308A and 310A. In this embodiment, side members 308A and 310A are generally triangular and have a pair of aligned apertures 312A. The apertures 312A may be cast as a part of the one-piece pivot connection or one-piece side member, or may be machined after the pivot connection 300A has been cast. Moreover, bosses could be welded or otherwise secured to the side members.

Preferably, a brace, crosspiece or gusset 318A extends along the longitudinal axis (i.e., extends at least partially in the longitudinal direction) of the pivot connection 300A between the arms 308A and 310A. Generally, axial brace 318A preferably follows the outer edge profile of the arms 308A and 310A (i.e., the bottom edges) in order to provide the desired support to the arms, though many other support arrangements could be used. Brace 318A is formed with a leading portion or leg 321A that extends generally forward of pivot hole 312A, and a trailing portion or leg 323A that extends generally rearward of pivot hole 312A. In this embodiment, brace 318A is a continuous support but it could be defined with gaps.

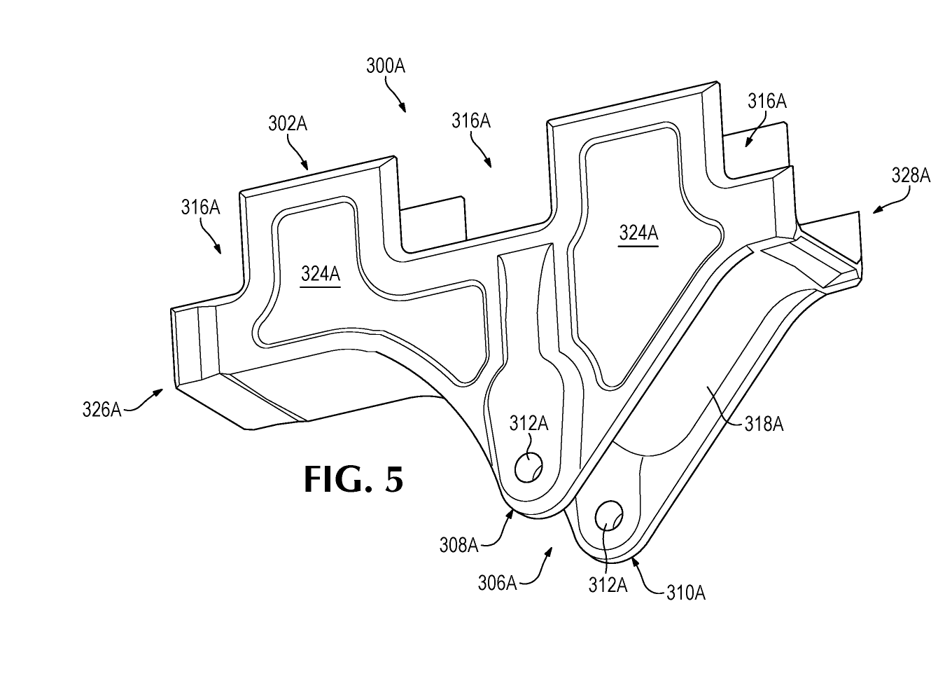

In order to allow clearance for the truck chassis 106, the brace 318A in this example defines a relief portion 320A, i.e., where the brace is shallower than the bottom profile of the arms 308A and 310A. The brace is preferably formed with opposing converging portions or spans (straight or curved) that end in a rounded peak (projecting downward) but other shapes are possible. The peak is spaced above and slightly forward of aperture 312A to provide sufficient support to arms 308A, 310A and sufficient clearance for the truck chassis. In the illustrated embodiment, the rear or trailing portion lies along or generally along the outer edge of arms 308A, 310A, and the front or leading portion is spaced slightly below the outer edge of arms 308A, 310A, though other arrangements are possible. Preferably, the leading portion has a steeper slope than the trailing portion to better support the loads. The use of a downward projecting peaked brace is beneficial for restraining the deflecting of arms 308A, 310A. The recessed formation of the peak above and forward of the aperture is beneficial to avoid conflict with the truck chassis during the raising and lowering of the truck body. The brace and/or side members could have various configurations to provide the support and clearance needed for the particular truck body and truck chassis so that side members of the pivot connections are not subjected to undue deflection, and the pivot connections do not limit the range of motion of the pivot connection or damage the truck chassis or truck body as the load is dumped. As can be seen in FIG. 5 brace 318A does not interfere with the truck chassis 106 as the truck body 200 is rotated about the pivot pin 400.

In addition to axial brace 318A, the pivot connection 300A may have one or more transverse brace or support 322A that extends from the mounting end 302A to the brace 318A between the arms 308A and 310A, though a shorter extension is possible. Transverse support(s) 322A provides additional support to the pivot connection 300A. In the illustrated embodiment, support 322A is a vertically oriented support (when the truck body is at rest), centrally located, and aligns generally with pivot hole 312A; many other arrangements of braces or supports could be used. In alternative embodiments not shown, the area between the mounting end 302A and the brace 318A may, for example, be a solid or have a series of intersecting longitudinal and horizontal gussets. In this embodiment, the combined use of axial and transverse braces 318A, 322A provides improved support for side members 308A, 310A.

When the pivot connection is cast (or otherwise formed as a one-piece component) it is possible for the pivot connection to have complex shapes to optimize the fit and strength needed for the particular use.

Various benefits can be gained by forming the pivot connection or the side members as a one-piece component. The pivot connection may, for example, be thicker around the apertures or through holes 312A on each arm 308A and 310A and have gentle smooth transitions to the other parts of the pivot connection 300A. These improved transitions that are relatively free of sharp edges or corners limit the stress concentration within the part. In addition, various portions of the pivot connection 300A (e.g., a portion(s) of the coupling portion 306A and mounting portion 302A) may be thinned or provided with depressions 324A formed into the part to reduce thickness of the part where the greater thickness is not needed. Strategically reducing the thickness of the part can significantly aid in improved manufacturability. An additional benefit is a reduction in the weight of the pivot connection without unduly reducing its strength and durability of the pivot connection. The weight of the pivot connection will vary depending on the configuration of the pivot connection and size of dump truck the pivot connection is to be used with. In some cases, a standard pivot connection may weigh in excess of 800 pounds. The amount of weight savings that can be achieved by thinning the walls or providing recesses will vary depending on the size and usage of the pivot connection.

In an alternative embodiment, the pivot connection 300A forms an integral part of the chassis rails 214. When the pivot connection is installed as a part of the chassis rail the pivot connection or hinge portion is designed into the rail to provide longitudinal support to the truck body as well as a pivoting connection. For example, each chassis rail can consist of a forward portion and a separate rearward portion. In this alternative construction of the invention, the pivot connection bridges or joins the forward portion and the rearward rail portion to act as a chassis support component. The chassis support component overlaps the rails portions and is attached to the rail portions by welding or other means. The chassis support piece mounts to the rails 214 at mounting portion 302A. Similar to other pivot connections a pivot portion extends below the mounting portion. The front end 326A of the mounting end 302A of the pivot connection may lie over the forward rail portion and the rear end 328A may also lie over the rearward rail portion. Both the front end and rear end of the chassis support may lie under the chassis rails, one end may lie over one chassis rail and the other end may lie under the other chassis rail, or one of the ends may have sections that lie over the chassis rail and sections that lie under the chassis rail. Alternatively, the pivot connection can be welded into a recess formed in the chassis support.

In an alternative embodiment shown in FIG. 8, the pivot connection 300B is installed over and secured to the chassis rails 214 of the truck body 200. This is particularly useful in retrofitting truck bodies with a prior art pivot connections though it can be used for new truck body constructions as well. For example, a pivot connection 300A may be removed from the truck body 200 and a pivot connection 300B may be installed in its place. Pivot connection 300B may generally have the same geometry as pivot connection 300A or may have varied geometry. In this embodiment, pivot connection 300B is shown generally as having the same geometry as pivot connection 300A and only varies in that the pivot connection 300B has additional protrusions 330B that extend horizontally parallel to the ribs 212 and bottom floor 222 of the truck body 200. The additional protrusions 330B may provide additional strength and surface area for welding the pivot connection 300B to the truck body 200.

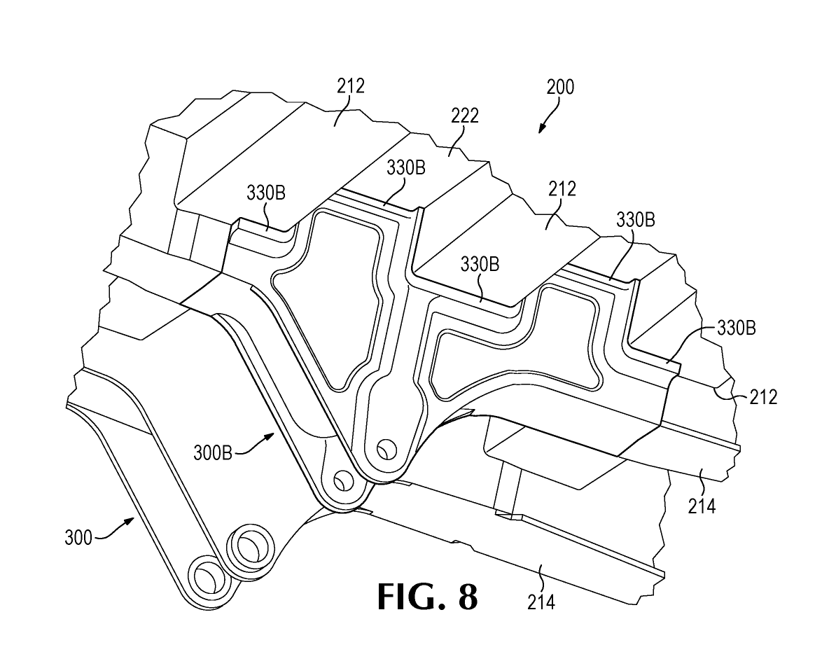

In an alternative embodiment shown in FIGS. 9 and 10, a two piece pivot connection 300C is provided. Pivot connection 300C is similar in many ways to pivot connection 300A with many of the same benefits and purposes. The following discussion focuses on the differences and does not repeat all the similarities that apply to pivot connection 300C. FIG. 9 shows a one-piece side member 310C that forms half of the pivot connection 300C, and FIG. 10 shows the second one-piece side member 308C that is generally a mirror image of piece 310C and forms the second half of the pivot connection 300C. One side member 308C of the pivot connection 300C is aligned so that the gusset 318C is aligned with the gusset 319C on the other piece 310C of the pivot connection 300C. The two side members 308C and 310C are welded or otherwise secured together along the split gusset 318C and 319C. Once the two side members 308C and 310C are welded together, pivot connection 300C resembles the shape and form of pivot connection 300A. A two piece pivot connection may be beneficial if a one piece pivot connection is too large to cast or if the geometry is too complicated. Welding the pieces 308C and 310C along gussets 318C and 319C places the welds in areas where the pivot connection will experience low stress and minimizes the likelihood that the pivot connection will fail at the weld. In this way, the benefits of one-piece pivot connection (i.e., to reduce deflection, stress and weight savings) can be achieved with two one-piece side members centrally welded along the braces (axial and/or transverse) for an easier and less expensive casting process.

In an alternative embodiment shown in FIG. 11, mounting portion 302A extends upward to mount to a lower portion of rail 214. Sidewalls of the mounting portion extend part way up the side of the rail and are spaced from ribs 212 when installed. This configuration avoids the extensions and recesses around the ribs, which can be less complex to manufacture. Further, with a more limited perimeter less welding for installation of the pivot connection.

In an alternative embodiment shown in FIGS. 12-17, a pair of cast side members or arms 308D and 310D form a pivot connection 300D. The pair of arms 308D and 310D are secured in an arced recess 224 in the chassis rail 214 of the truck body 200. Chassis rails 214 are shown with extensions 215 protruding lower than adjacent portions of the chassis rails and arced recesses 224 formed in the bottom outer edges 217 of the extensions 215.

In some cases the chassis rails may be large enough and strong enough to form recesses 224 directly into chassis rails 214 without the need for extensions 215 (not shown). In this case, the recess on the chassis rail extends into the chassis rail and the bottom of the recess is higher than adjacent portions of the chassis rail. The height of the pivot connection can be varied to allow the pivot connection 300D sufficient clearance to allow the truck body to pivot.

In this embodiment the two arms 308D and 310D making up the pivot connection 300D are identical. The arms 308D and 310D are generally triangular with an aperture 312D for receiving the pivot pin. A through-hole 322D may extend through the aperture 312D for receipt of a securement mechanism, such as a collar or split ring (not shown), for limiting axial movement of the pivot pin 400 within the aperture 312D. A lifting eye 334D may be secured to the arms 308D and 310D. The lifting eye 334D may be located anywhere on one of the arms 308D and 310D as long as the lifting eye does not interfere with the pivoting movement of the truck body once the pivot connection is installed. The lifting eye 334D may, for example, be secured to the bottom of the arms 308D and 310D. The pivot end 306D gently tapers to a mounting end 302D so that the pivot end 306D is thicker than the mounting end 302D.

The outer edge 303D of mounting end 302D is arced from the front end 326D to the rear end 328D to correspond to the arced recess 224 in the chassis rail 214. While it is preferable for the mounting end 302D to be generally arced from the front end 326D to the rear end 328D the mounting end 302D may have other arcuate or linear shapes (e.g., sinusoidal) that provide smooth transition so that when the arms 308D and 310D are welded to the chassis rail 214 the stresses at the joint will be minimized.

One or more braces or gussets 318D, similar to braces 318A or 322A, may be welded or otherwise secured between the arms 308D and 310D in order to support the arms as discussed above for the other embodiments. Brace 318D could be a cast member or formed plate steel and welded to each of the arms 308D, 310D. Alternatively, one-half of brace 318D could be formed on each arm 308D, 310D similar to the embodiment in FIGS. 9 and 10. While it is preferred for the pivot connection 300D to have a gusset 318D supporting the arms 308D and 310D, there are still manufacturing, weight savings and economic benefits in a pivot connection without a gusset 318D supporting the arms 308D and 310D. The gusset 318D may, for example, be a cast member or be made of a plate steel. Pivot connection 300D is preferably formed of separate cast members (i.e., side members and braces) welded together, but could also be a one-piece cast (or otherwise manufactured) pivot connection.

If pivot connection 300D is to be used as a replacement for an existing pivot connection 300A secured to the truck body 200, an arced recess could be cut in pivot connection 300A and pivot connection 300D could be welded into the recess. Alternatively, an arced recess could be cut in an extension separate and apart from the chassis rail and pivot connection 300D can be welded into the recess. The extension may, for example, be made of a plate of steel. The pivot connection could first be secured within the recess in the extension and then secured to the chassis rail or the extension could first be secured to the chassis rail and then the pivot connection could be secured within the recess.

The above disclosure describes specific examples of a pivot connection for use with dump trucks. The pivot connection includes different aspects or features of the invention. The features in one embodiment can be used with features of another embodiment. The examples given and the combination of features disclosed are not intended to be limiting in the sense that they must be used together.

1. A hinge structure providing rotation of a truck body on a truck frame comprising a mounting portion to attach to the truck body, pivot members projecting below the mounting portion at a mid-portion of the structure to receive a pivot pin coupling the truck body to the truck frame, and a brace between the pivot members extending from a front portion to a back portion generally following the projecting pivot members.

2. The hinge structure of claim 1 where the mounting portion of the hinge structure conforms to a rail of the truck body.

3. The hinge structure of claim 1 where the brace is proximate the mounting portion at the front portion and the back portion of the structure and is spaced from the mounting portion at the mid portion of the structure.

4. The hinge structure of claim 1 where the hinge structure at least in part is cast.

5. The hinge structure of claim 1 where the hinge structure is a cast one-piece member.

6. The hinge structure of claim 1 where the brace is welded to the pivot members.

7. The hinge structure of claim 1 where the projecting pivot members each include a hole that are aligned with each other to receive a pin to join the truck frame to the truck body.

8. The hinge structure of claim 7 where the brace is spaced from the aligned holes to provide clearance for the truck frame.

9. A pivot connection to connect a truck body to an off-road, mining truck frame comprising spaced side members each having a mounting portion and a projecting pivot portion, where the side members are joined by a crosspiece that generally follows the periphery of the projecting pivot portion to limit relative motion of the side members.

10. The pivot connection of claim 9 where the side members are cast.

11. The pivot connection of claim 9 where the pivot connection is cast as a single unit.

12. The pivot connection of claim 9 where the mounting portion is configured to mount to a rail of the truck body.

13. The pivot connection of claim 9 where the crosspiece following the periphery of the projecting side members is recessed relative to the outer edges of the side members.

14. The pivot connection of claim 9 where the crosspiece leading portion generally extends toward the front end of the truck body from the pivot axis, and the trailing portion generally extends toward the rear end of the truck body from the aperture.

15. The pivot connection of claim 9 where the crosspiece has differing slopes extending away from the pivot axis.

16. The pivot connection of claim 9 where the crosspiece leading portion has a steeper slope than the trailing portion.

17. The pivot connection of claim 9 where the pair of spaced side members include thinned wall portions and/or recesses.

18. The pivot connection of claim 9 where the pivot portions each include an aperture the apertures aligned along a pivot axis to receive a pin.

19. The pivot connection of claim 18 where the thickness of the side member at the aperture that receives the pin is greater than the thickness of the mounting portion.

20. The pivot connection of claim 18 where the crosspiece is recessed from the apertures to ensure proper clearance during rotation of the truck body.

21. The pivot connection of claim 18 including a medial transverse support generally aligned with the apertures to interconnect the side members above the crosspiece.

22. The pivot connection of claim 18 where the crosspiece includes a leading portion and a trailing portion that converge as they extend away from the mounting portion toward the pivot axis for the truck body.

23. A hinge portion for a truck body comprising side plates connected by an arcuate transverse support between them, each said side plate including a coupling portion that are aligned with each other to receive a pin to connect the hinge portion to a truck frame.

24. The hinge portion of claim 23 where each said side plate includes a mounting portion spaced from the coupling portion that connects to a rail of the truck body such that the side plates connect to opposite sides of the rail extending along the length of the truck body.

25. The hinge portion of claim 24 where the transverse support is proximate the mounting portion at forward and rear portions of the hinge portion and the transverse support diverges from the mounting portions in the intermediate portion.

26. The hinge portion of claim 24 where the coupling portions extend away from the mounting portions and extend beyond the transverse arcuate support.

27. A pivot connection with spaced side members each member having a front edge, a rear edge, a mounting portion and a pivot portion where the front edge and rear edge converge generally toward the pivot portion, and each mounting portion includes an arc-shaped outer edge.

28. The pivot connection of claim 27 where the mounting portion is adapted to mount in an arced recess in a truck body chassis rail to limit stress between the pivot connection and the chassis rail.

29. A truck body comprising a pair of opposite sidewalls, a front wall and a floor that are joined together to define a payload bed, and a hinge structure providing rotation of the truck body on a truck frame, the hinge structure including a mounting portion to attach to the truck body, pivot members projecting below the mounting portion at a mid-portion of the structure to receive a pivot pin coupling the truck body to the truck frame, and a brace between the pivot members extending from a front portion to a back portion generally following the projecting pivot members.

30. A hinge structure for an off-road mining truck body comprising side members connected by an arcuate crosspiece between them to limit relative motion of the side members, each said side member including a coupling portion, the coupling portions on the respective side members being aligned with each other to receive a pin to connect the hinge portion to a truck frame, the crosspiece including a leading portion and a trailing portion that converge toward each other to define a peak spaced from the coupling portions.

31. A hinge structure in accordance with claim 30 wherein the crosspiece is welded to the side members.

32. A hinge structure in accordance with claim 30 wherein the peak of the crosspiece being spaced forward and above where the coupling portions support the pin.

33. A hinge structure in accordance with any of claims 30 wherein the leading portion and the trailing portions have different slopes as they extend away from the peak.
